(19) United States
(12) Patent Application Publication
(10) Pub. No.: US 2009/0294498 A1
(43) Pub. Date: Dec. 3, 2009

(54) Aerodynamically shaped stowage receptacle for vehicles

(76) Inventors: Michael William Landgraf, Saratoga, CA (US); Hans Joachim Von Der Pfordten, Palo Alto, CA (US)

Correspondence Address: MICHAEL WILLIAM LANDGRAF, 13781 PIERCE RD, SARATOGA, CA, 95070, US

(21) Appl. No.: 12/454,829

(22) Filed: May 22, 2009

Related U.S. Application Data
(60) Provisional application No. 61/130,691, filed on Jun. 2, 2008.

(51) Int. Cl. B60R 9/06

(52) U.S. Cl. 224/493; 224/522

(57) ABSTRACT

An aerodynamically shaped storage receptacle for vehicles comprises a six-panel receptacle body, an upper support system of three straps and a lower support system of two straps. At the ends of these straps are metal clamps to affix the receptacle onto a lift gate or trunk lid, such that the gate or lid can be opened with the receptacle attached. If needed inflatable plastic bags can fill out the receptacle which in an aerodynamic shape can achieve a substantial fuel saving for a respective vehicle, estimated at about 10%.

### CROSS-REFERENCE TO RELATED APPLICATION

This non-provisional application claims the benefit of the Provisional Application No. 61/130,691, filed by Michael Landgraf and Hans J. Von Der Pfordten on Jun. 18, 2008.

### FIELD OF THE INVENTION

This invention relates to automobile accessories, specifically to an auxiliary luggage receptacle attachable to the rear of a vehicle.

### BACKGROUND OF THE INVENTION

For many families, a sports utility vehicle (SUV), van, minivan, sedan or station wagons are popular. In an era of fuel efficiency and smaller vehicles, the interior space and passenger comfort and capacity are widely recognized benefits. A common consumer criticism of these vehicles is a lack of cargo space when the vehicle is transporting a full load of passengers. Stowage space, generally regardless of make or model is limited to a rather small area behind the rear-most seat. Various car stowage configurations are described which however fail to meet all desirable features. There remains a need for a product that increases stowage capacity of vehicles, such as SUV's, minivans, sedans, which has a strap suspension system to secure a container or receptacle to the vehicle where it is easily loaded, allows access the lift gate or trunk when attached, and has an aerodynamic configuration that improves air flow and fuel efficiency of the vehicle, and can be protected by the vehicle body from road litter.

### SUMMARY OF THE INVENTION

A primary purpose of the invention is to increase the stowage or luggage carrying capacity of various types of motor vehicles, using a receptacle and an adjustable strap system for connecting the receptacle to the vehicle.

An additional purpose of the invention is a stowage receptacle that can be located on the rear lift gate or trunk lid using a strap support system that securely attaches a receptacle to the lift gate of the vehicle, thereby ensuring stable positioning of the receptacle and allowing opening of the lift gate or trunk with the receptacle attached. These attributes and others are satisfied by an auxiliary baggage carrier with three major elements: a fabric receptacle, a system of upper support straps that are connecting the receptacle to the upper edge of the lift gate, and a system of lower support straps that connect the receptacle to the lower edge of the lift gate and that serve to stabilize the receptacle from swaying and allow opening the lift gate or trunk lid while the receptacle is attached to the vehicle. The receptacle has an aerodynamic configuration and is made from a sturdy material as are the support straps. These straps are placed in a way such that the receptacle can be attached to the rear of a vehicle, while keeping its trunk accessible.

### BRIEF DESCRIPTION OF THE DRAWINGS

FIG. 1 shows the streamlines over a moving vehicle and the influence of a properly shaped receptacle

FIG. 2 shows the main components that comprise the aerodynamically shaped stowage receptacle.

FIG. 3 illustrates the side and top views of a passenger vehicle with the aerodynamically shaped stowage receptacle attached.

FIG. 4 shows the suspension strap system that attach to the top and bottom of the baggage stowage system.

FIG. 5 shows the suspension system and how the upper and lower strap system and metal hooks attach to the top, side and bottom edges of the vehicle lift.

### DESCRIPTION OF THE PREFERRED EMBODIMENT

The present invention tries to establish an optimum compromise between receptacle drag reduction (thus saving fuel), space utilization, easy accessibility (of the trunk or lift gate) and universality (fitting different rear shapes of vehicles). It can be described in several configurations with respect to the size and shape of a receptacle and with respect to the pattern of attachment of the upper and lower support straps. The basic function of the upper support straps is to secure the receptacle to a vehicle and to hold its weight. The basic function of the lower support straps is to restrain the receptacle to the vehicle body allowing the lift gate to be opened when the receptacle is attached. In the following examples, upper and lower suspension straps are secured directly to the receptacle. The lower suspension straps can also removably attached in each of the following examples. “Lift gate” in the following is a general expression and includes a “hatch” of a hatch-back car and a trunk lid.

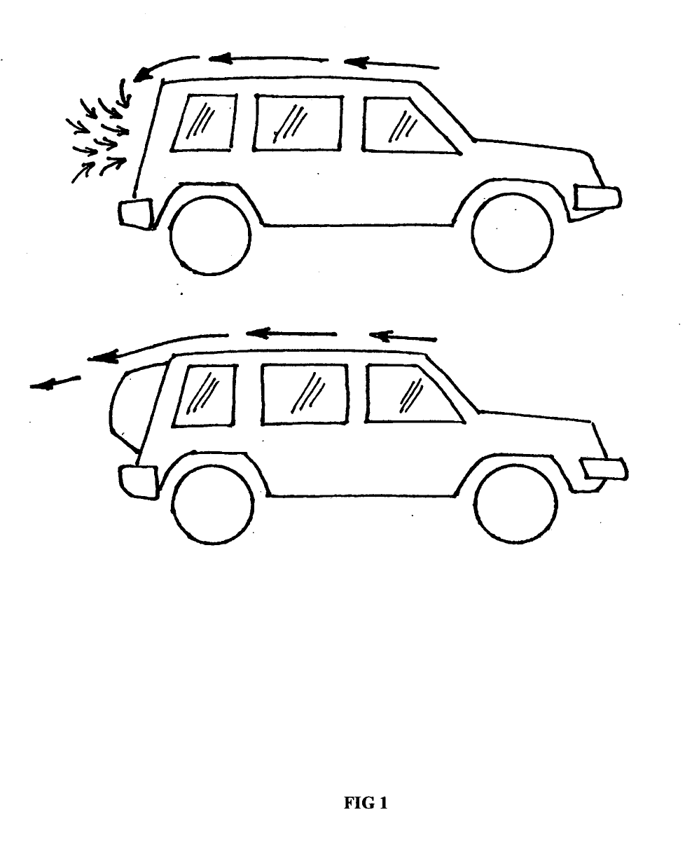

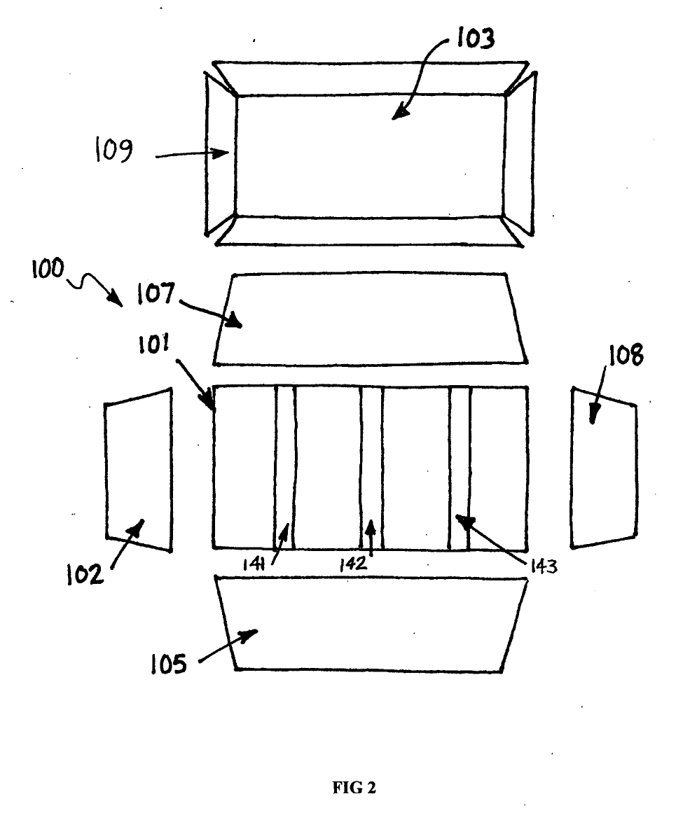

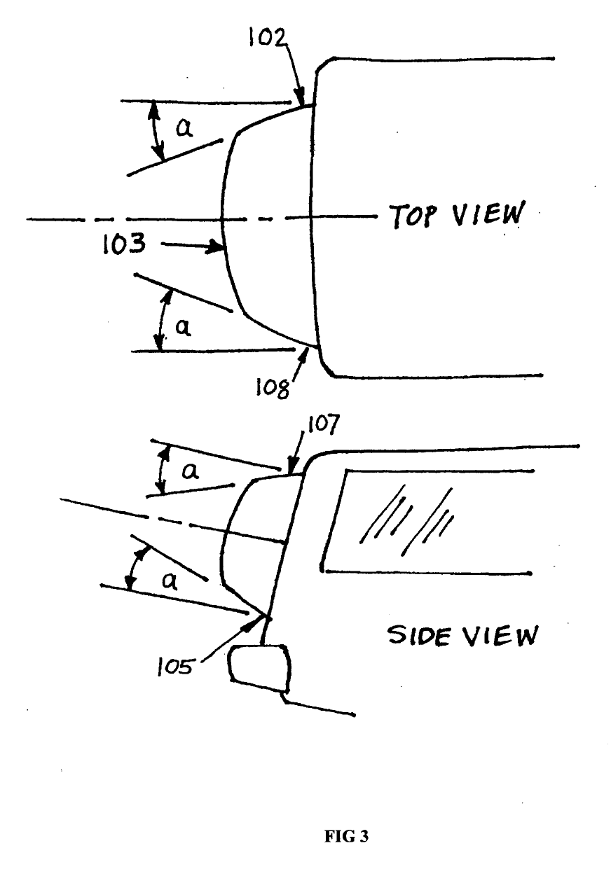

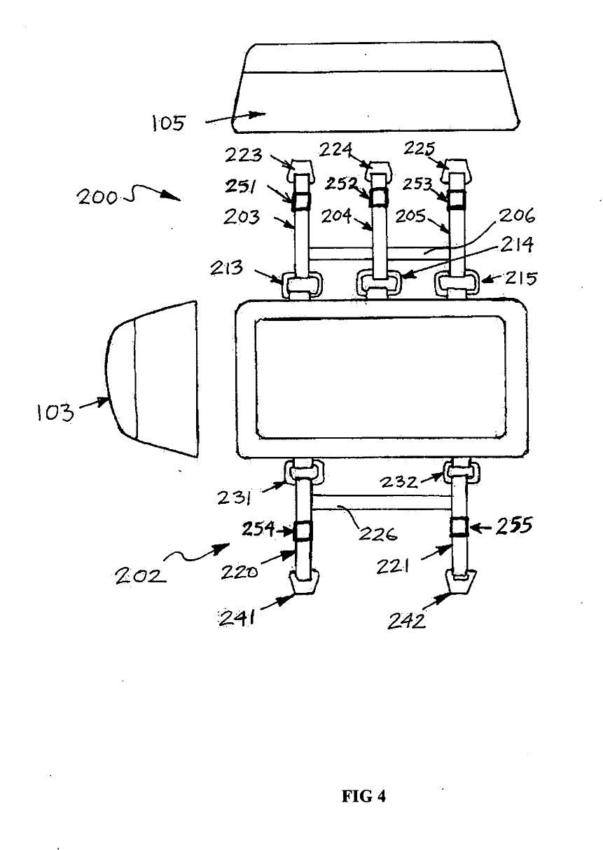

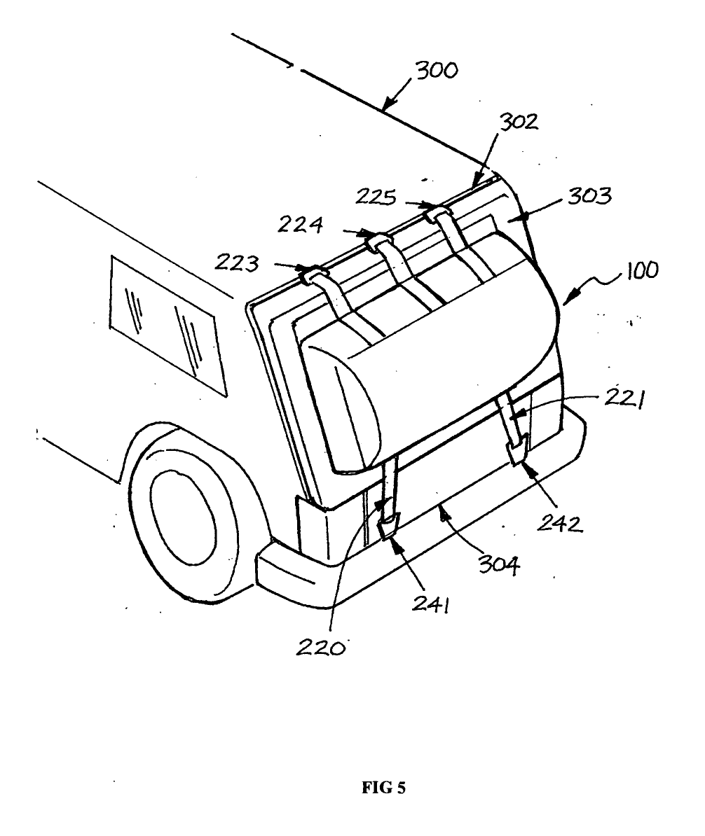

FIG. 1 shows the streamlines over a vehicle with energy-consuming vortices with “eddy” currents and the beneficial effect of a rear mounted receptacle approximating a streamlined shape. The elements of the receptacle 100 are illustrated in FIG. 2. In order to clarify the description and nomenclature of receptacle 100 and its components, here they are viewed as lying unattached on the ground. The six-sided receptacle 100 is assembled by joining designated edges of the several panels. Although various adhesives and heat sealing means can be used to join the edges, machine-stitching is the preferred way to form the seams joining adjacent panels. The receptacle 100 comprises a bottom panel 101, possibly made out of a soft friction-producing composition that keeps the receptacle from swaying laterally when attached to the rear of a vehicle. Bottom panel 101 is fortified by sewn stripes 141, 142 and 143, made out of sturdy fabric and stretching equidistantly across bottom panel 101, parallel to its small axis. Left (102) and right (108) side panels as well as lower panel 105 and upper panel 107 are trapezoidal and tapered towards the center axis of the assembled receptacle 100 to form an aerodynamically shaped hollow body when sewn together with panels 102 and 108 and cover panel 103 as illustrated in FIG. 4. The left and right panels 102 and 108 and the top and bottom panels 107 and 105 form the opening of receptacle 100 and are angled inward towards the center axis of the receptacle as seen in FIG. 3. These angles a are equal and preferably around 10 degrees. The opening of the receptacle 100 carries a No 10 zipper. The cover panel 103 is configured with a convex geometry facing away from the vehicle to improve air flow. On its outer rim it carries a counterpart of the No 10 zipper and is surrounded by peripheral flaps 109, as depicted in FIG. 2., on all four edges to cover the seams of the assembled receptacle 100 for rain protection of the closed zipper of the assembled and fully loaded receptacle 100. The six panels need not be separated. For example, the bottom panel 101 and two end panels 102 and 108 may be formed from a single piece of material with seams stitched or otherwise formed only to achieve the desired form of the receptacle. The same is true for panels 101, 105 and 107. When the receptacle is positioned on the rear of a vehicle as shown in FIG. 5, the bottom panel 101 is adjacent to and pressed against the rear of the vehicle. The top cover 103 faces away from the vehicle.

The completed receptacle 100 of FIG. 2 illustrates which edges are connected and how the receptacle is formed. The aerodynamically shaped stowage receptacle 100 may be fabricated from a variety of materials. A bi-layered synthetic material made of vinyl covered polyester is useful as it is adequately water resistant to protect the contents of the loaded receptacle that has reasonable light weight, and secure seams can be stitched to join the panels of the receptacle. Other synthetic fabrics and materials are suitable including nylon, metal, thermoplastic sheet and various polyesters and various types of cotton material. One or more inflatable bladder structures (not shown) can be integrated into the receptacle 100 to fill out any voids between baggage or cargo pieces to obtain an aerodynamic shape. A zipper such as a No. 10 zipper is stitched along the full length of the rims of left panel 102, the top panel 107 and the right panel 108 and a corresponding portion of the rims of the bottom structure, the rims of panels 108 and 105, to secure the closure means. A 2 inch (5 cm) flap may be stitched the full length of the zipper and attached above the zipper to form a protective flap (not illustrated).

The exact dimensions of the receptacle 100 are not critical, but are reasonable limited by practical considerations of the vehicle on which it is to be secured. The length of the receptacle varies from 102 to 122 cm (40 to 49 inched) and is preferable about 100 cm (46 inches). The width varies from 60 to 66 cm (24 to 26 inches), preferably approximately about 66 cm (26 inches, and the depth varies from approximately 38 to 62 cm (15 to 20 inches).

As illustrated in FIG. 4, the upper support system 200 comprises three support straps 203,204 and 205 as well as a perpendicular strap 206 between straps 203, 204 and 205. The latter are permanently attached along the length of the seam between panels 101 and 107 of the receptacle by metal clips 213, 214 and 215 respectively. These clips are not needed if straps 203, 204 and 205 are directly sewn into the seam between panels 101 and 107. The other ends of straps 203, 204 and 205 are fastened to metal hooks 223, 224 and 225, respectively, allowing the bag to attach to the upper edge 304 or the side edges of lift gate 301 of vehicle 300.

As seen in FIG. 4, the lower support system 202 comprises two straps 220 and 221, connected by a perpendicular strap 226. The lower strap 220 and 221 can be sewn into the seam between panels 101 and 105 along the bottom edge of the receptacle 100. The lower straps 220 and 221 can also be removably fastened to the the lower seam of receptacle 100 by metal clips 231 and 232, respectively. The other ends of straps 220 and 221 can be symmetrically anchored to two points on the side or bottom 304 of a lift gate 301 via metal hooks 241 and 242 to allow the lift gate to be opened with the receptacle 100 attached. Straps 220 and 221 may also carry sliding buckles 254 and 255 for adjusting the length and tension of the whole strap support system to prevent swaying. All support straps are made of 1.5 inch webbing. The material is strong and resistant to stretching and resistant to ultraviolet rays.

The stowage receptacle when fully filled out creates an aerodynamic configuration, similar to a boat tail to improve air flow behind a vehicle. In initial field tests on a station wagon, the aerodynamically shaped stowage receptacle improved fuel mileage by about 10%. This is result correlates to the range 10-15% improvement documented by other aerodynamic fairings or shortened boat tail plates on semi-trailers.

What is claimed is:

1. A vehicle baggage stowage system, comprising:
a) a receptacle for enclosing luggage and cargo, being aerodynamically shaped to streamline airflow behind a vehicle to which it is attached, and to reduce drag, thus enabling a reduction in fuel consumption for the vehicle, the receptacle also having side walls that are tapered towards the center axis of the receptacle and having a convex top cover for improved streamlined air flow, and having a fortified waterproof material to resist wear and tear; and
b) a set of adjustable straps for connecting the receptacle to the vehicle and ending in fasteners to attach to upper, lower and side edges of a rear inclined surface of a vehicle such that the latter can be opened with the receptacle attached.

2. The baggage stowage system of claim 1, wherein
a layer, preferably of a soft friction-producing composition is placed between the back surface of the vehicle and the receptacle for preventing the receptacle from swaying when the vehicle is in motion.

3. The baggage stowage system of claim 1, wherein
the system also comprises stretchable and flexible bags for filling the voids left by arbitrarily shaped and stored baggage in the interior of the receptacle, when inflated to air mattress pressure, to produce the built-in aerodynamic shape of the receptacle which saves energy when the vehicle is in motion.

4. A method for stowing luggage on the back of a vehicle in an attached receptacle for enhancing cargo transportation and fuel economy, comprising the steps of:
a) providing a fabric receptacle which when filled with luggage has an aerodynamic configuration thus reducing drag;
b) providing flexible straps connected to the receptacle and ending in fasteners;
c) fastening the receptacle via the straps and fasteners to upper, lower and side edges of the rear such that the rear inclined surface of a vehicle can be opened with the receptacle attached.
